(19) United States
(12) Patent Application Publication
(10) Pub. No.: US 2021/0339056 A1
(43) Pub. Date: Nov. 4, 2021

(54) Respirator to Accommodate Facial Hair

(71) Applicant: Joseph R. Allgeier, Victor, NY (US)

(72) Inventor: Joseph R. Allgeier, Victor, NY (US)

(21) Appl. No.: 17/244,653

(22) Filed: Apr. 29, 2021

Related U.S. Application Data
(60) Provisional application No. 63/047,023, filed on Jul. 1, 2020.
(60) Provisional application No. 63/017,530, filed on Apr. 29, 2020.

(51) Int. Cl. A62B 7/10; A62B 18/08; A62B 23/02; A62B 9/00; A62B 18/06; A41D 13/11

(52) U.S. Cl. CPC A62B 7/10; A62B 18/084; A62B 23/02; A41D 13/1161; A62B 18/08; A62B 18/06; A62B 9/00

(57) ABSTRACT

The present invention provides an exemplary respirator which may be worn effectively by individuals with beards or other non-conventional facial features such as deep scars. The respirator preferably comprises a means to either seal or plug the user's nose to prevent the user from breathing air in through their nose and also a main housing further comprising a mouth piece, a filter housing, a saliva collector, means for attaching a strap to the main housing, and a strap to keep the mask positioned properly on the user's face. The filter housing is preferably sized to accommodate a removeable dust cartridge and a removeable fume cartridge.

### FIELD OF THE INVENTION

The present invention relates to an item of personal protective equipment to enable a respirator to be worn effectively and comfortably by an individual with facial hair.

### BACKGROUND OF THE INVENTION

In many industrial, academic, and residential settings, respirators need to be worn to prevent individuals from breathing contaminated air. The contaminants could be dust, particulate matter, chemical vapors, toxic fumes, pathogens, or other similar easily aerially transmitted hazards which may become airborne either directly or in a fluid such as water vapor that becomes aerosolized. And now, in light of the current COVID-19 virus crisis individuals need to wear masks or respirators to simply perform normal, everyday activities to prevent the transmission of virus between individuals. A common solution used to prevent individuals from inhaling such hazardous materials has been the half face respirator. With a proper fit and optimized selection of cartridges to remove hazardous materials from the air the wearer breathes, these half face respirators are effective at eliminating health hazards for the wearer in a majority of instances. The half-face respirator also provides the benefit, above that of a full-face respirator or a self-contained breathing apparatus, in that it is not overly burdensome in most cases for the wearer to use and also may be worn with other standing personal protective equipment (PPE) such as safety glasses, goggles, full face shields, ear muffs, hard hats and the like. The half-face respirator's compact size, covering little more than the wearer's mouth and nose, is a key reason that wearers can combine it with other items of PPE in relative comfort. And that is a feature that ideally would be maintained in an improvement over the current state of the art.

While these are effective for a majority of individuals, these do not perform as effectively as necessary for people with many common facial features which include beards, pronounced scarring, non-pronounced noses, particularly squared jaws, and severely deforming injuries, surgeries, or birth non-normalities, and the like.

Individuals with these voluntary or involuntary facial features cannot get a standard half-face respirator to fit effectively on their face and the efficiency of the respirator is reduced, oftentimes critically. Depending upon the particular hazard that one is attempting to avoid, wearing an ill-fitting respirator may provide essentially no protection to the wearer, such as with the case of chemical vapors or fumes. Even a small gap in the seal between the respirator and the individual's skin may be enough to allow for the wearer to suffer severe injury up to and including dying.

Breathing Clean air is a basic human right of every man (bearded or not), woman, and child. There is no “One Size Fits All” version of a half-face respirator that will universally fit every human face. Bearded men and other individuals with non-standard facial features have no affordable alternative in respiratory protection that allows them to keep their facial hair and/or preserve their identity and dignity while also protecting themselves from hazards in the workplace and at home.

There have been attempts to design respirators that are to be worn by individuals with facial hair such as beards and/or mustaches, but they each have limitations of their own. Though at this time, men with beards do not have many options when it comes to respiratory protection. The Powered Air Purifying Respirator (PAPR) (manufactured by 3M of St. Paul, Minn.) is the only Occupational Safety and Health Administration (OSHA) approved method of respiratory protection for men with facial hair. This product combines a full-faced shield and battery-powered air pump to supply air to the user. While the effectiveness of this system has been proven, the enormous cost of this system is a prohibitive factor for the average person gaining access to one. A PAPR system costs around $1300 on the low end of the price spectrum and can increase to well above $2000 on the high end. This system also needs a clean space for storage which is another cost of around $300. This financial burden makes the PAPR rare in many public and private sector situations. This system also has additional limitations in that it covers the user's entire face, it is heavy, and it requires a power source. There remains a need for a light weight, non-powered, cost effective solution to provide better protection to a user with features such as facial hair.

Another option for individuals with facial hair is the Resp-O-Rator™ (manufactured by Duxterity LLC of Marshville, Ohio) which costs around $50. This unit works in a similar way to scuba gear using the mouth to create a seal around the breathing apparatus and pinching the nose closed to direct the flow of air through the mouth. The cartridges are placed behind the head for a more compact design which fits underneath of welding masks and face shields. This unit is designed only for protection from dust so if a man is using it for welding or spray painting the protection from these toxic fumes is insufficient. This unit also can be unwieldy as the dust cartridges are located behind the user's head. These dust cartridges can interfere with other forms of PPE such as hard hats or ear muff style hearing protection. The large tubes wrapping around a user's head also might get snagged by an obstacle in a non-well controlled environment such as what could occur in an emergency situation or when working on machinery or other equipment. A need for a more compact solution where the respirator will not interfere with other forms of PPE and will also protect from a wider range of contaminants remains.

The last option for individuals with facial hair is to go without any protection at all and face the hazard. While this option is free from financial cost the health risks are substantial and not recommended as this option as we are now learning with the current COVID-19 crisis may be deadly.

A better solution to the problem of how to effectively and efficiently protect those with facial hair or other non-typical facial features is necessary and the present invention, the beard accommodating respirator (referred to optionally as the B respirator for short), provides this solution. The B respirator, can make the decision between shaving, safety, cost, and convenience very simple. The present invention provides an affordable and safe alternative to the other products that are offered on the market currently. As will be described herewith, the B respirator relies on a mouth piece and a nose plug without using a skin contact seal. This device is compact enough to be compatible with all other types of safety equipment including safety glasses, ear muffs, face shields, and hard hats.

### SUMMARY OF THE INVENTION

The B respirator provides an affordable, comfortable, alternative to conventional half face respirators currently on the market today. This piece of safety equipment allows men who have beards to protect themselves from potential hazards in the workplace and at home. This new design is adjustable and conforms to the individual's facial features. The B respirator is compact enough so that the user does not have to choose between what to protect on their body. As it is important to keep safety gear close for convenience, the B respirator's compact and portable design allows the user to carry it along and place into service as the user encounters hazards. The B respirator takes into account several ergonomic factors such as being light weight. It allows the user to not have to choose between wearing a respirator or other forms of personal protective equipment (PPE) as the B respirator is adaptable to additional PPE such as safety glasses, hearing protection, and face shields. The B respirator utilizes a mouth piece and a nose plug to protect the user from a combination of dust and fume hazards. A seal is created using the mouth so facial features do not interfere with creating an airtight seal as would be the case with a conventional sealing method. The B respirator is also a light weight, compact alternative for both men and women that want respiratory protection that does not interfere with other forms of PPE including face shields, safety glasses, hearing protection, hard hats, and the like. In one preferred embodiment of the present invention the B respirator will allow for an airtight seal to be formed between the B respirator and the wearer's nose and mouth without the aid of a lubricating gel. In another preferred embodiment of the B respirator, the aforementioned seal will be enhanced with the aid of a lubricating gel. In yet another preferred embodiment of the present invention, the B respirator will seal beneath the lower lip rather than around the jawline where the most beard hair is present. Additional features of the B respirator will be the consideration of comfort that is placed on the usage and fit of the straps which are used to keep the B respirator in place while in use as well as the comfort of the seal around the wearer's nose. Referring to FIG. 1A, a preferred embodiment of a user wearing an exemplary B respirator is depicted. As can be readily observed, the B respirator allows for a seal between the B respirator and the wearer's nose and mouth even if the wearer has facial hair that would prevent other respirators and masks of the prior art from forming a seal. FIG. 1B depicts the back of the head of the wearer of the B respirator allowing for a view of a preferred embodiment of the head strap keeping the B respirator in place. FIG. 1C depicts a representative example of a wearer using the B respirator along with other items of personal protective equipment (PPE). In FIG. 1C, the wearer combines the B respirator with a full-face shield, hearing protection, and a hard hat. FIG. 1D depicts the B respirator minus the filter cartridge and the dust cartridge.

### BRIEF DESCRIPTION OF THE DRAWINGS

Embodiments of the present invention will be described by reference to the following drawings, in which like numerals refer to like elements, and in which:

FIG. 1A depicts a preferred embodiment of a user wearing the respirator of the present invention;

FIG. 1B depicts a back view of a preferred embodiment of a user wearing the respirator of the present invention;

FIG. 1C depicts a preferred embodiment of a user wearing the respirator of the present invention along with other items of PPE;

FIGS. 2A-21 depict isometric and cross sectional views of a preferred embodiment of the respirator of the present invention;

FIG. 2J depicts a frontal view of the B respirator 1100 without the filter cartridge nor the dust cartridge installed;

FIG. 3 depicts an exploded view of a preferred embodiment of the present invention;

FIG. 4 depicts a reverse view of the respirator;

FIG. 5 depicts a B respirator of the present invention using an alternative means for supporting the nose piece of the invention;

FIG. 6 depicts an exploded view of the preferred nose piece of the present invention;

FIGS. 7A, 7B, and 7C depict preferred embodiments of the respirator of the present invention with lights for communication with others;

FIG. 8 depicts a user wearing another preferred embodiment of the respirator of the present invention;

FIGS. 9A and 9B depict additional exploded views of the second preferred embodiment of the respirator of the present invention;

FIG. 10 depicts another preferred embodiment of the present invention—a respirator designed for use by a child;

FIG. 11 depicts a user wearing another preferred embodiment of the respirator of the present invention;

FIG. 12 depicts a frontal view of the B respirator 100 without the filter cartridge nor the dust cartridge installed;

FIG. 13A depicts another preferred embodiment of the respirator of the present invention;

FIG. 13B depicts a cross sectional view of another preferred embodiment of the respirator of the present invention;

FIG. 14 depicts an exploded view of another preferred embodiment of the present invention;

FIGS. 15A-15D depict another preferred embodiment of the present invention;

FIG. 16 depicts the backside of a second embodiment of the mouthguard respirator in use;

FIG. 17 depicts another preferred embodiment of the present invention—a mouthguard or escape respirator;

FIG. 18 depicts another preferred embodiment of the present invention—a respirator designed for usage by an individual who breathes through a tracheotomy;

FIGS. 19A-19C depict versions of another preferred embodiment of the present invention—respirators designed for usage by animals.

### DETAILED DESCRIPTION OF THE INVENTION

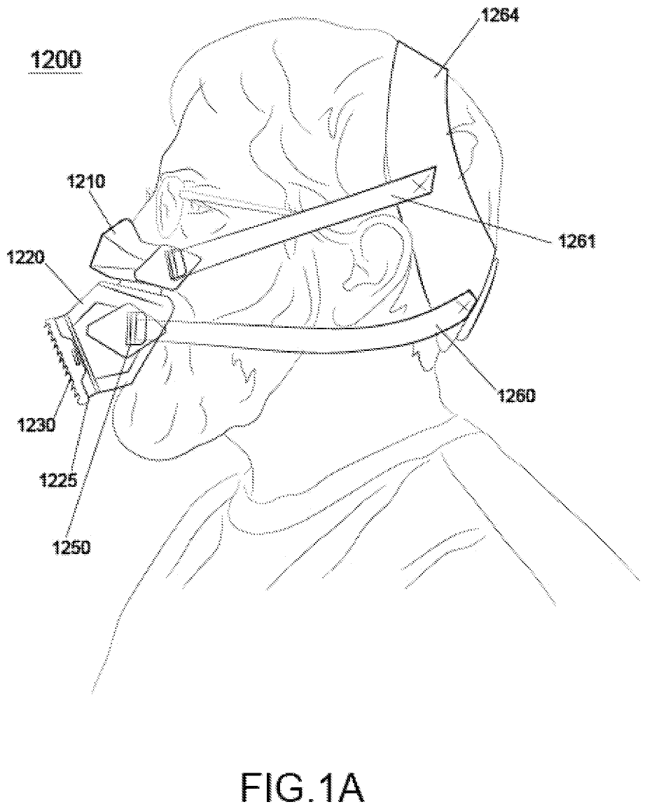

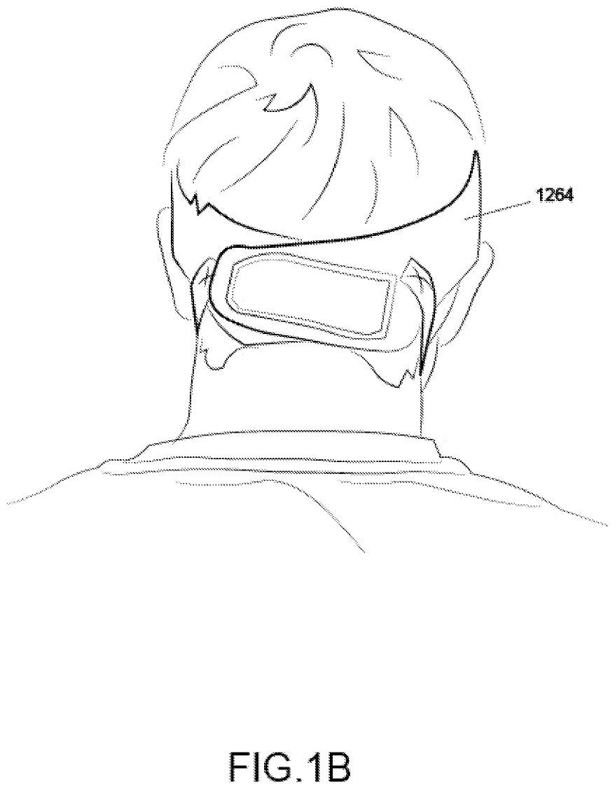

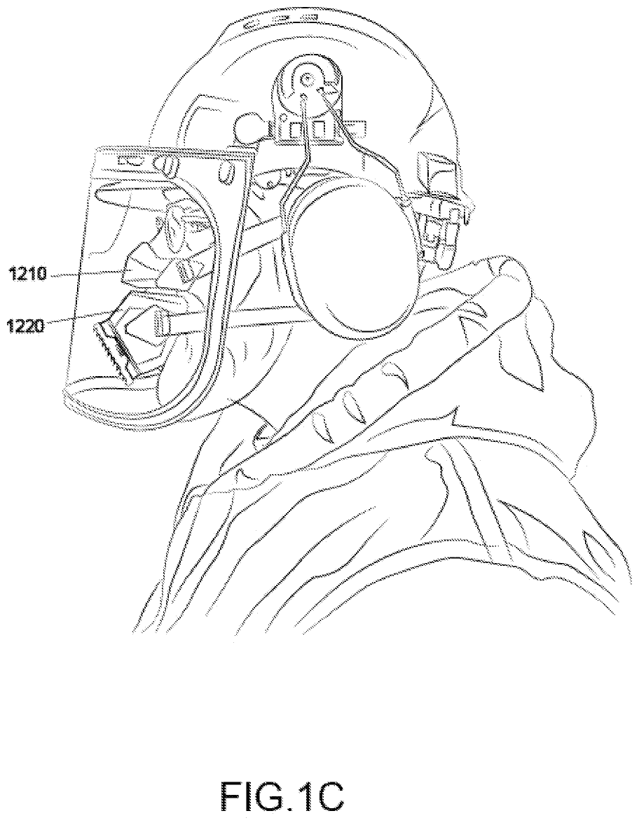

The present invention provides an exemplary respirator which may be worn effectively by individuals with beards or other non-conventional facial features such as deep scars. For simplicity, the respirator of the present invention is referred to as the B respirator which is short for beard accommodating respirator. Referring to FIG. 1A and the preferred embodiment of the present invention in use depicted therein, the B respirator 1200 comprises an internal nose plug 1210 to allow the user to breathe in air in through their nose in addition to the respirator providing the ability to breathe through their mouth and also a main housing 1220 further comprising a mouth piece (not observable in FIG. 1A), a filter housing 1230, a saliva collection portion 1240 (also referred to as a saliva collector or a saliva well), means for attaching a strap to the main housing 1250, and a strap 1260 to keep the mask positioned properly on the user's face. In the preferred embodiment, the filter housing is sized to accommodate a removeable dust cartridge (not observable in FIG. 1A) and a removeable fume cartridge (not observable in FIG. 1A). It is preferable to have the dust cartridge installed first, so ambient air passes through the dust cartridge first and then through the fume filter as this prevents the fume filter from getting clogged with dust that might be in the air which could significantly reduce the life of the fume filter. The dust cartridge can be used on its own or along with the fume filter. The fume filter should be accompanied by the dust cartridge to prevent a short service life. As those skilled in the art are aware, fume filters are widely available from safety supply vendors and a conventional fume filter such as that comprised of activated charcoal, other chemical adsorbing material, and the like may be used. Additionally, the dust filter may be a standard cloth fabric dust filter, a fiber dust filter, a HEPA filter, an N95 quality mask filter, or the like. In the embodiment of the present invention depicted in FIG. 1A, there is additionally an access panel 1225 which may be removed to allow for easier access to and installation of the dust cartridge and fume filter. In the embodiment of the present invention depicted in FIG. 1A, the access panel 1225 is sized to snap into place in the main housing 1220 via a pair of tabs built into the access panel 1225 which allow for the access panel to remain securely fixed in place against the main housing which prevents air from bypassing the filters when entering the respirator. As those skilled in the art are aware, there are other readily available means to attach the access panel 1225 to the main housing 1220 including a pressure fit along with a gasket; wherein the gasket being preferably comprised of a compressible elastomer such as rubber. Additionally, as those skilled in the art are aware, the access panel 1225 is an optional feature of the present invention. One could design a respirator which does not include the access panel 1225 without deviating from the teaching of the present invention; the access panel 1225 makes it easy to replace the cartridge and filter but each may be installed into the filter housing without use of the access panel 1225.

The back side of the preferred head strap for keeping the B respirator securely fastened to the user's head is depicted in FIG. 1B. As those skilled in the art are aware, other means for keeping the B respirator securely fastened to the user such as using a pair of elastic straps, using a pair of strings which tie together in back of the user's head, a pair of straps each equipped with a snap, and the like may be used without deviating from the teachings of this invention.

The main housing is preferably sized to be compact around a user's mouth and frontal portion of their face to allow for accommodation of additional pieces of PPE by the wearer as depicted in FIG. 1C wherein the wearer is shown using the B respirator along with a face shield, a hard hat, and hearing protection. The main housing “cradles” the user's lower lip. The main housing also ergonomically contours to the user's face for better weight distribution. The main housing is preferably comprised of a polymer such as high density polyethylene (HDPE), acrylonitrile butadiene styrene (ABS), nylon, or the like.

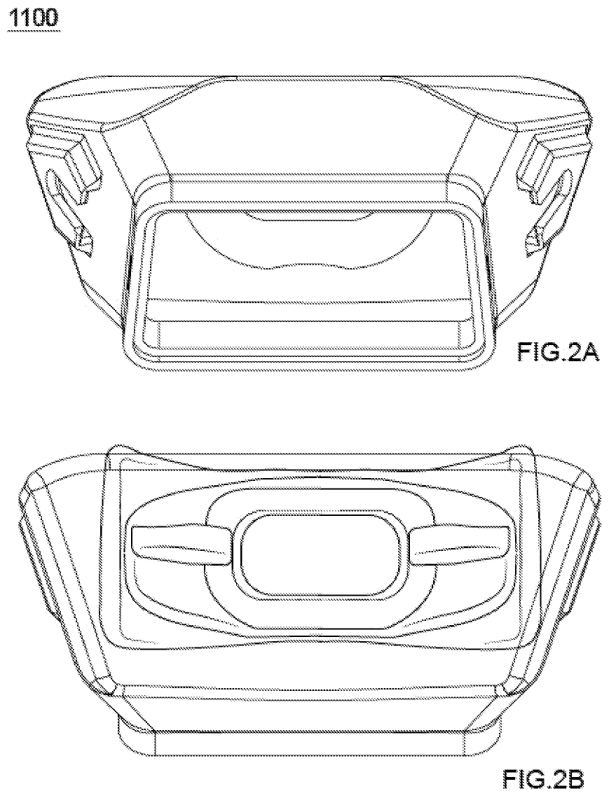

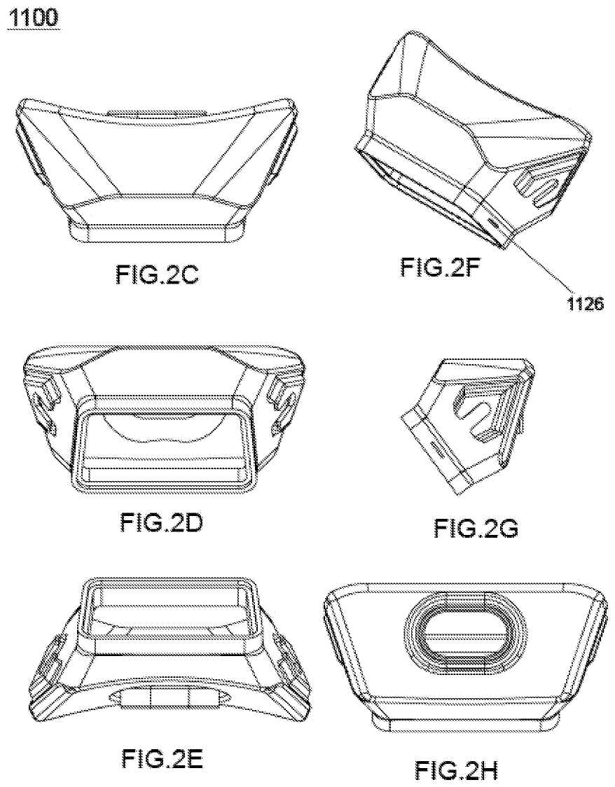

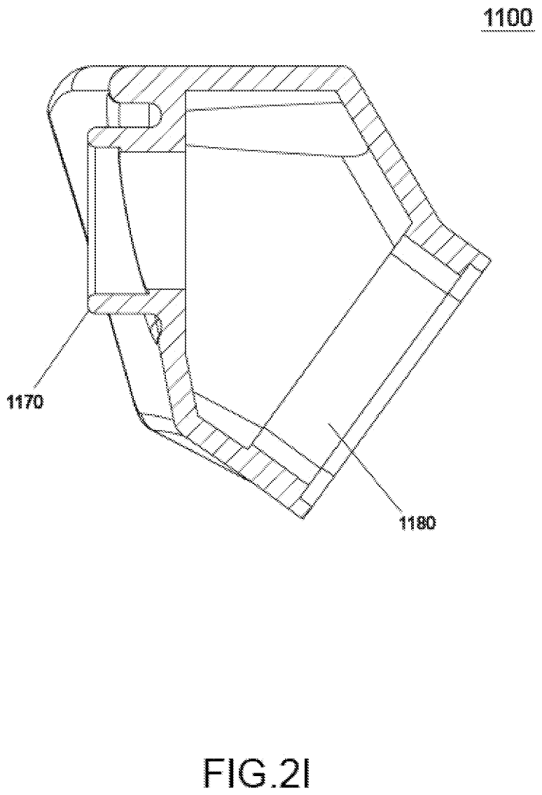

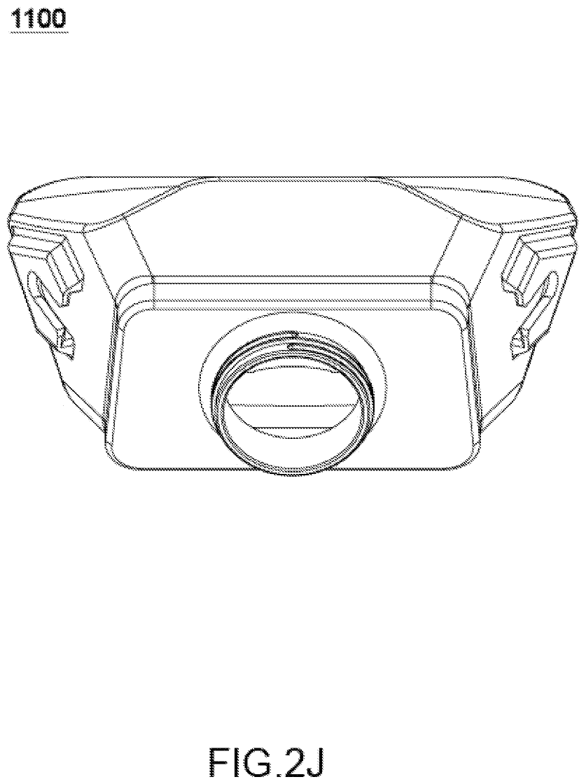

FIGS. 2A-21 depicts a cross sectional view of another exemplary respirator 1100 of the present invention. In FIGS. 2A-21, the mouthpiece 1170, dust cartridge 1180, fume filter 1190, and access panel tabs 1126 are visible. Additionally, there is a barrier 1145 which prevents aerosolized droplets of saliva and other fluids such as mucus from impinging upon both the fume filter 1190 and the interior of the main housing 1110. Saliva and other fluids will feed by gravity into the saliva collector 1140.

FIG. 2J depicts a frontal view of the B respirator 1100 without the filter cartridge nor the dust cartridge installed.

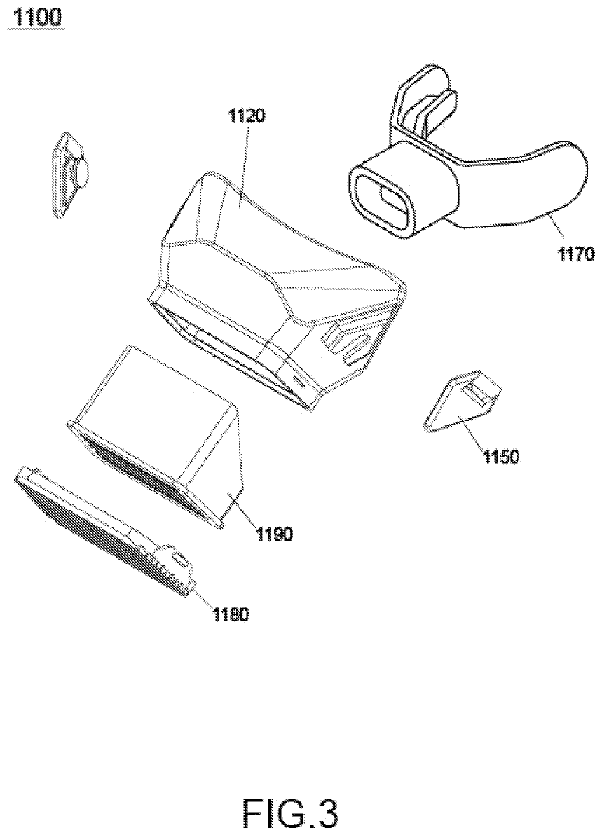

FIG. 3 depicts exploded views of the exemplary respirator 1100 of the present invention.

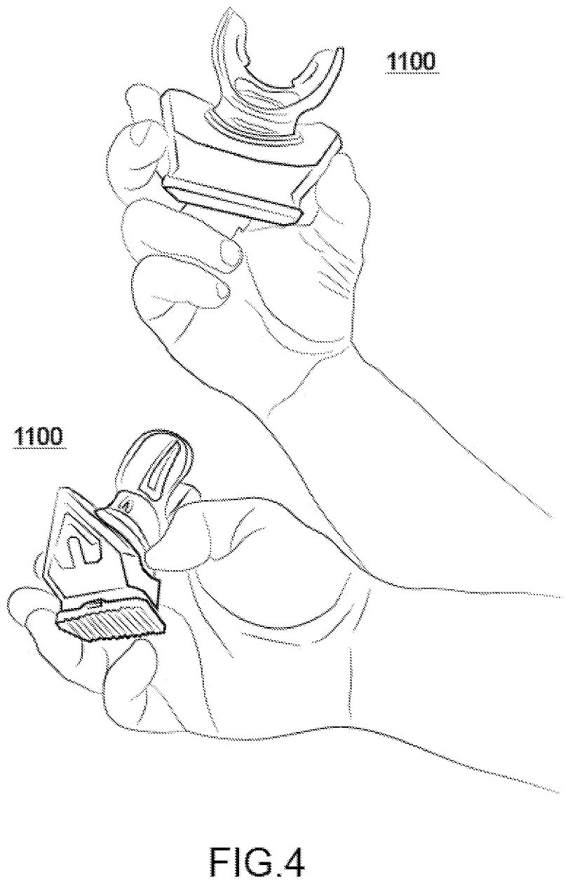

FIG. 4 presents alternative isometric views of the exemplary respirator 1100 of the present invention in a user's hand depicting how a user might hold the respirator 1100 while preparing to place it in service in the user's mouth.

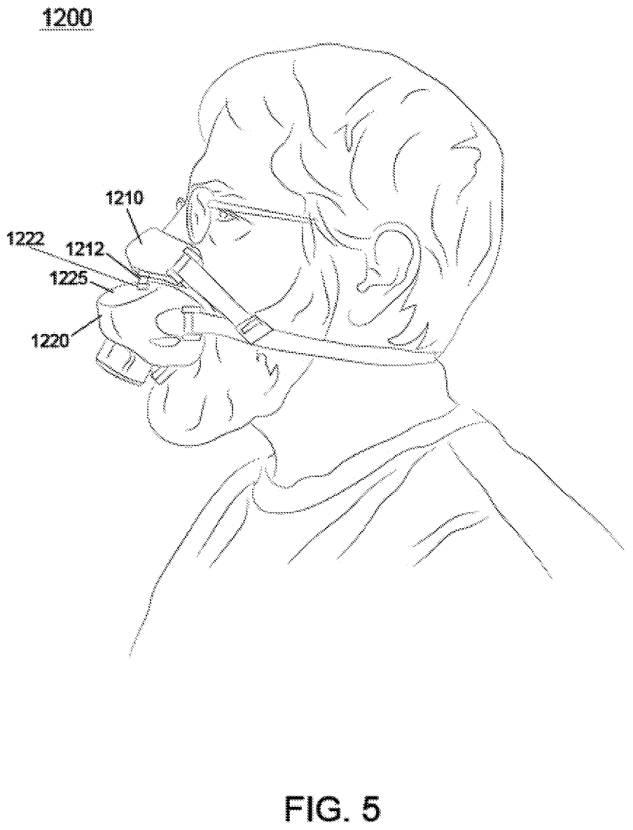

FIG. 5 depicts the B respirator 1200 in use by a user. The internal nose plug 1210 which is a component of the complete B respirator 1100 will be described further here. The internal nose plug 1210 is fitted and attached to the main housing 1220 so that the individual wearing the respirator is still able to breathe through their nose in addition to breathing through their mouth. In the embodiment depicted in FIG. 5, the internal nose plug 1210 is connected to the main housing 1220 via two small tubes 1212 which fit into the internal nose plug 1210 on a first end and which fit into the main housing 1220 via an access panel 1225. The access panel 1225 is fitted with two housings 1222 which allow each of the two small tubes 1212 to snuggly fit into a housing 1222. In the preferred embodiment depicted in FIG. 5, the two small tubes are comprised of a flexible polymer such as surgical silicone tubing or the like. Additionally, the tubing may have a lubricating gel placed on the outer surface of the tubing to ease insertion of the tubing into the access panel housings 1222. The nose piece 1210 is preferably constructed in a manner similar to that of the main housing of the B respirator out of a rigid or semirigid material such as acrylonitrile butadiene styrene (ABS), high density polyethylene (HDPE), or the like. The nose piece 1210 may optionally include an additional elastic strap to minimize the possibility of misplacing the nose piece 1210 when the device is not in use. This additional elastic strap may be connected to the nose piece 1210 and the main housing 1220 via readily available means such as elastic band or cordage. This additional elastic strap also preferably has a buckle to allow for the user to change out nose pieces readily.

In the first preferred embodiment depicted in FIGS. 1A-1D, and 2-5, there is a single opening in the B respirator which accommodates inhaling and exhaling. In another preferred embodiment, there is an additional “flapper” valve which allows the air exhaled from the user to leave through the separate exhaust port. This version helps prevent the filters from getting clogged by exhaled water vapor but also may allow for extremely small amounts of the ambient air and any contaminants in it to enter the respirator; so this version is preferably only used for non-life threatening environments such as keeping wood dust out of the user's respiratory system and would not be used for keeping out pathogens as an example.

The mouthpiece creates a seal with the user's lips. That is a key factor in how the respirator allows the user to have facial hair or other facial features which would render a standard half face respirator inoperable as it would be unable to create a seal with the user's face.

In the preferred embodiment, the head strap helps carry some of the weight of the respirator and allows the user to wear the B respirator without sustaining jaw fatigue. The B respirator has been designed to maintain weight around the mouthpiece rather than entirely above or below the mouthpiece which helps to allow the B respirator to seem lighter than it is to a user. It is preferable for the head strap to be comprised of two ½″ elastic bands each terminating in ½ of a buckle such as a snap buckle to allow for ease in securing and then removing the buckle when the wearer places the B respirator into service and then removes it from service.

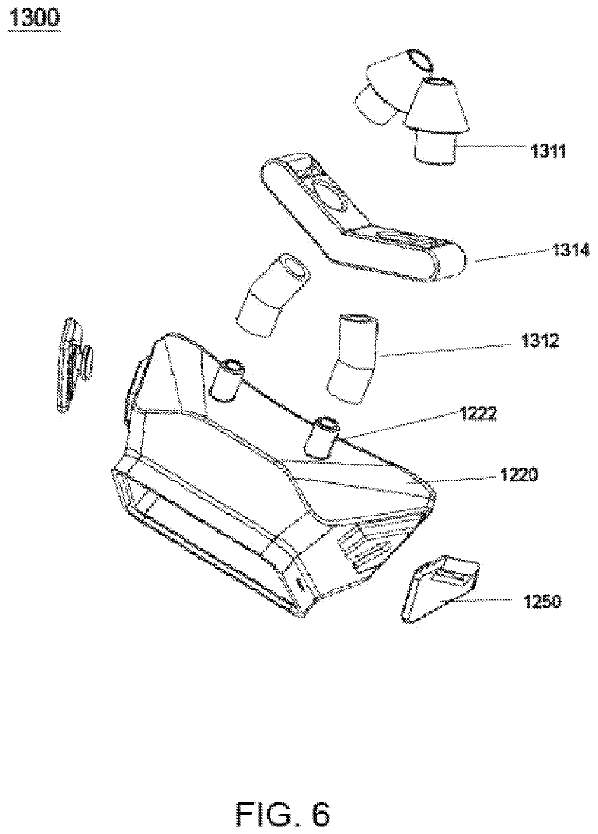

FIG. 6 an exploded view of a respirator similar in design and function of the B respirator 1100 depicted in FIGS. 1A-1C and 2-5 has been presented wherein an alternative nose piece 1310 replaces the internal nose piece 1210 of the prior embodiment. The internal nose piece 1310 is fitted and attached to the main housing 1120 so that the individual wearing the respirator is still able to breathe through their nose in addition to breathing through their mouth. In the embodiment depicted in FIG. 6, The internal nose piece 1310 is preferably comprised of two nose inserts 1311 (also referred to as nasal pillows) each of which is inserted into a user's nostril to make a contact seal with the nostril. The nasal pillows 1311 are each comprised of a flexible material such as silicone rubber which allows for the nasal pillows 1311 to be placed comfortably within the nostril and make a seal. The two nasal pillows 1311 fit on their other end into a nose insert support 1314 which is preferably made of a rigid or semirigid material such as HDPE, ABS, and the like. Each nasal pillow is designed with a shape similar to that of a pine tree to have a flare top wider than the base which narrows towards the top of the nasal pillow. This helps to create the seal between the nasal pillow and the user's nostril. The nose insert support 1314 provides additional structural support to the nasal pillows 1311 as they fit into the user's nostrils. A pair of hoses 1312, preferably made of a flexible material such as silicone rubber connect the nasal pillows 1311 to the main housing of the B respirator. Each hose 1312 connects into the nasal pillow support 1314 on one end and into the respirator access tube 1222 on the other end. Straps, preferably made of an elastic material such as Nylon 6,6, will hold this system firmly against the wearer's head, comfortably holding the contact seal with the nostrils.

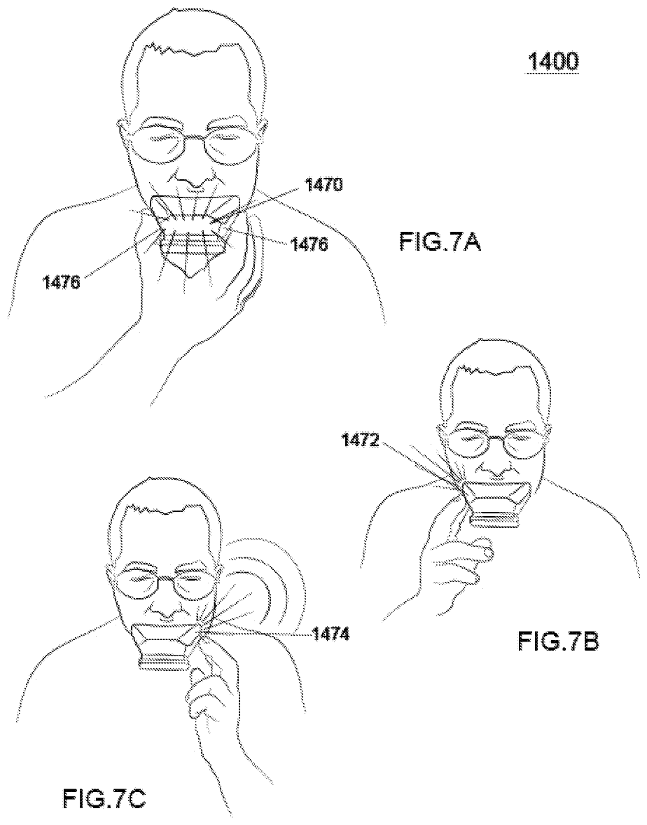

FIGS. 7A-7C depict a B respirator 1400 comprising the B respirator 1100 with a set of lights attached to the respirator. The lights may be used to communicate non-verbally with others and also to provide additional illumination to a poorly lit environment. The lights are preferably controlled by pressing the light 1476. It is preferable that the lights be different colors from each other to assist in communication with others. In the preferred environment, one light is red 1472, one light is green 1474, and the light in the front which provides for illumination is white 1470. The red light and the green light are used for communication purposes. The white light provided illumination. As the user cannot speak clearly when using the B respirator, the lights allow the wearer to answer simple yes and no questions. Pressing the green light for ‘yes’ and the red light for ‘no.’ The lights can also be used to indicate that the wearer is or isn't in difficulty. When the wearer is in no distress, the green light can be lit. When the wearer is in distress, the red light can be activated to blink rapidly. As will be readily apparent to those skilled in the art, the lights may be any color combination without deviating from the teaching of this invention.

The lights can be attached to the b respirator via readily available means such as snap, clip, notch, slide, adhesive, and the like.

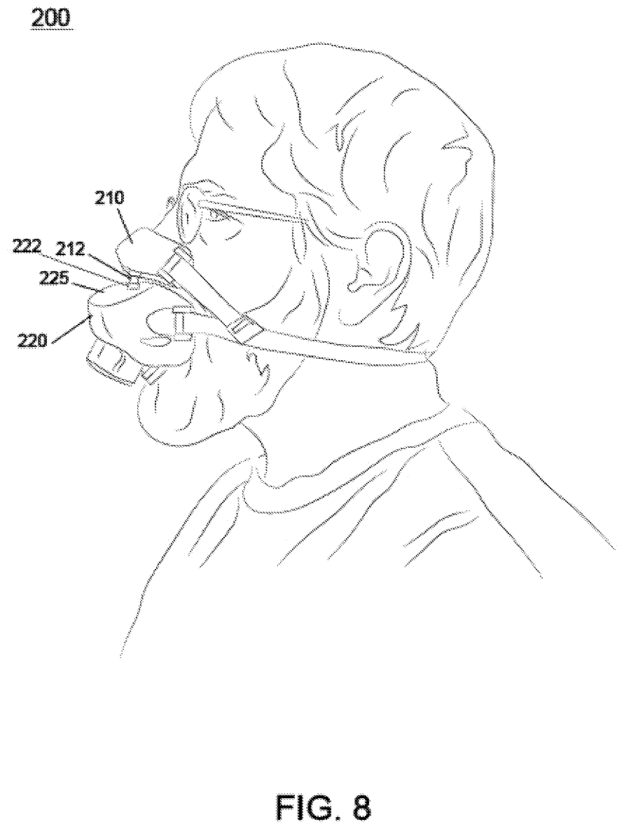

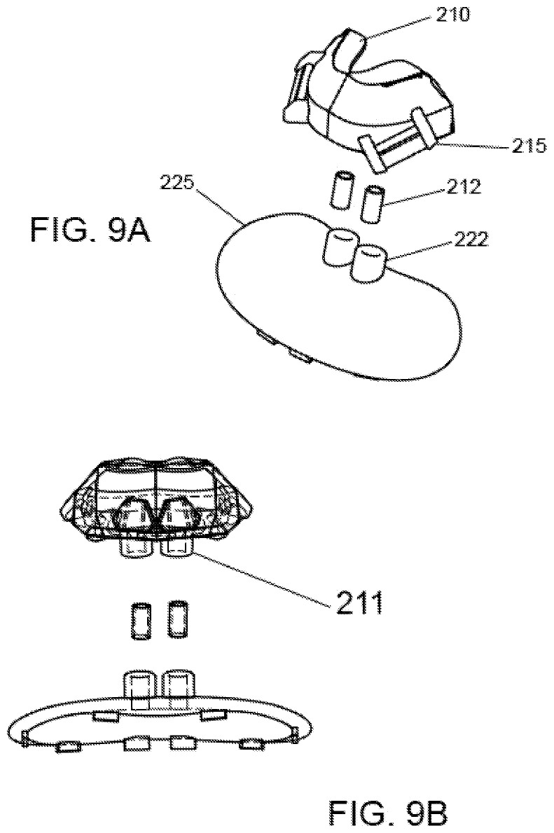

Referring to FIGS. 8, 9A, and 9B and another preferred embodiment depicted therein, a B respirator 200 similar in design and function to the B respirator 1100 depicted in FIGS. 1A-1C and 2-5 is in use and has been presented wherein another version of the internal nose piece 1210 is replaced with an alternative internal nose piece 210. The internal nose piece 210 is fitted and attached to the main housing 220 so that the individual wearing the respirator is still able to breathe through their nose in addition to breathing through their mouth. In the embodiment depicted in FIG. 8, the internal nose plug 210 is connected to the main housing 220 via two small tubes 212 which fit into the internal nose plug 210 on a first end and which fit into the main housing 220 via an access panel 225. The access panel 225 is fitted with two housings 222 which allow each of the two small tubes 212 to snuggly fit into a housing 222. In the preferred embodiment depicted in FIG. 8, the two small tubes are comprised of a flexible polymer such as surgical silicone tubing or the like. Additionally, the tubing may have a lubricating gel placed on the outer surface of the tubing to ease insertion of the tubing into the access panel housings 222.

FIGS. 9A and 9B provides an exploded view showing how the two small tubes 221 align with the two housings 222 of the access panel 225 of the main B respirator body. It is also evident from FIG. 9B that the internal nose piece 210 has two additional housings 211 which each allow for the each of the two small tubes 212 to fit snuggly into an additional housing 211. The internal nose piece 210 is preferably designed to contour around the wearer's nose and create a seal with the wearer's nose. To ensure a snug fit between the internal nose plug and the wearer's nose, an optional strap (not depicted) may be connected to the internal nose piece via means for attaching strap 215 and then having the optional strap pulled around the user's head. In this preferred embodiment where the nose piece is a separate piece not directly coupled to the main housing, the additional elastic strap helps prevent losing the internal nose piece 210. This elastic strap also preferably has a buckle to allow for the user to change out nose pieces readily.

In another preferred embodiment of the present invention not depicted, the saliva collector is equipped with a flap valve that allows saliva to enter into the saliva reservoir, but it cannot readily exit from the reservoir. This enables the B respirator to be worn more comfortably when the wearer needs to be moving around which would otherwise allow for saliva to “slosh” around in the reservoir and occasionally come in contact with the wearer's skin or facial hair which results in a rather uncomfortable feeling. The saliva collector preferably includes one or two small plugs to allow for easy draining of the collected saliva from the unit. Each saliva drain plug would be located at the lowest point of the saliva reservoir.

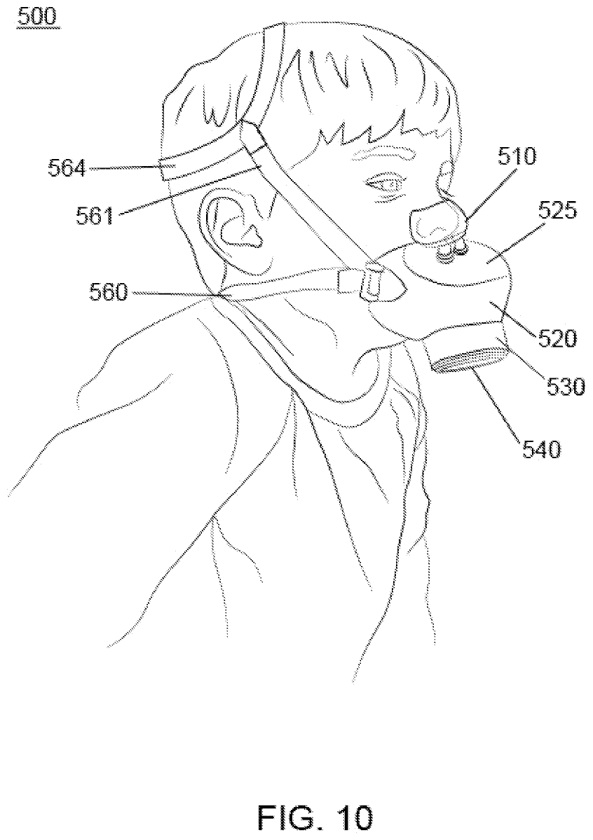

Referring to FIG. 10 and the preferred embodiment of the present invention in use depicted therein, a B respirator 500 for use by children is depicted. The B respirator 500 comprises a nose piece 510 to allow the child user to breathe air in through their nose as well as breathing through their mouth via a main housing 520 further comprising a mouth piece (not observable in FIG. 8; this mouth piece is similarly constructed as mouth piece 195 but is smaller to fit the child's mouth), a filter housing 530, a saliva collection portion 540 (also referred to as a saliva collector or a saliva well), means for attaching a series of straps to the main housing 550, and said series of straps. Said series of straps includes a neck strap 560, a head strap 564, and a pair of connecting straps 561 which links the neck and head straps 560, 564 and keep the mask positioned properly on the child user's face. In the preferred embodiment, the filter housing 540 is sized to accommodate a removeable dust cartridge and a removeable fume cartridge (not observable in FIG. 10). It is preferable to have the dust cartridge installed first, so ambient air passes through the dust cartridge first and then through the fume filter as this prevents the fume filter from getting clogged with dust that might be in the air which could significantly reduce the life of the fume filter. The dust cartridge can be used on its own or along with the fume filter. The fume cartridge should be accompanied by the dust cartridge to prevent a short service life.

In the embodiment of the present invention depicted in FIG. 10, there is additionally an access panel 525 which may be removed to allow for easier access to and installation of the dust cartridge 542 and fume filter. In the embodiment of the present invention depicted in FIG. 10, the access panel 525 is sized to snap into place in the main housing 520 via a pair of tabs built into the access panel 525 which allow for the access panel 525 to remain securely fixed in place against the main housing 520 which prevents air from bypassing the filters when entering the B respirator 500. As those skilled in the art are aware, there are other readily available means to attach the access panel 525 to the main housing 520 including a pressure fit along with a gasket; wherein the gasket being preferably comprised of a compressible elastomer such as rubber. Additionally, as those skilled in the art are aware, the access panel 525 is an optional feature of the present invention. One could design a respirator which does not include the access panel 525 without deviating from the teaching of the present invention; the access panel 525 makes it easy to replace the cartridge and filter but each may be installed into the filter housing without use of the access panel 525.

The main housing 520 is preferably sized to be compact around a child user's mouth and frontal portion of their face to allow for accommodation of additional pieces of PPE by the wearer. The main housing 520 “cradles” the user's lower lip. The main housing 520 also ergonomically contours to the user's face for better weight distribution.

The nose plug may be designed and function similarly to nose plug 210 but sized to fit a child rather than to fit an adult. The nose plug 510 may optionally be replaced by a nose clamp. The nose clamp may optionally include an additional elastic strap to minimize the possibility of misplacing the nose clamp when the device is not in use. This additional elastic strap may be connected to the nose clamp and the main housing 520 via readily available means such as via a plastic clip; a detachable two piece snap, a button and button hole, and the like. This additional elastic strap also preferably has a buckle to allow for the user to change out nose pieces readily.

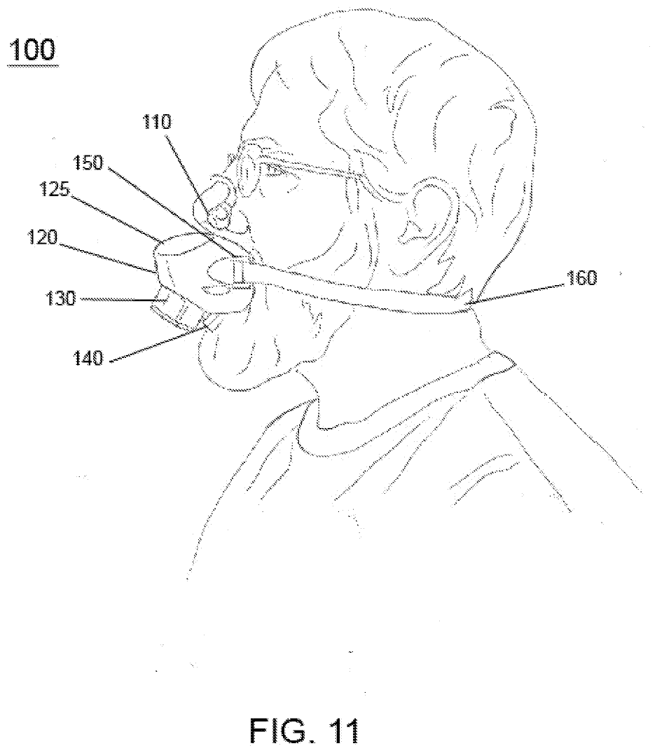

Referring to FIG. 11 and the preferred embodiment of the present invention in use depicted therein, the B respirator 100 comprises a nose clamp 110 to prevent the user from breathing air in through their nose and also a main housing 120 further comprising a mouth piece (not observable in FIG. 11), a filter housing 130, a saliva collection portion 140 (also referred to as a saliva collector or a saliva well), means for attaching a strap to the main housing 150, and a strap 160 to keep the mask positioned properly on the user's face. In the preferred embodiment, the filter housing is sized to accommodate a removeable dust cartridge (not observable in FIG. 11) and a removeable fume cartridge (not observable in FIG. 11). It is preferable to have the dust cartridge installed first, so ambient air passes through the dust cartridge first and then through the fume filter as this prevents the fume filter from getting clogged with dust that might be in the air which could significantly reduce the life of the fume filter. The dust cartridge can be used on its own or along with the fume filter. The fume filter should be accompanied by the dust cartridge to prevent a short service life. As those skilled in the art are aware, fume filters are widely available from safety supply vendors and a conventional fume filter such as that comprised of activated charcoal, other chemical adsorbing material, and the like may be used. Additionally, the dust filter may be a standard cloth fabric dust filter, a fiber dust filter, a HEPA filter, an N95 quality mask filter, or the like. In the embodiment of the present invention depicted in FIG. 11, there is additionally an access panel 125 which may be removed to allow for easier access to and installation of the dust cartridge and fume filter. In the embodiment of the present invention depicted in FIG. 11, the access panel 125 is sized to snap into place in the main housing 120 via a pair of tabs built into the access panel 125 which allow for the access panel to remain securely fixed in place against the main housing which prevents air from bypassing the filters when entering the respirator. As those skilled in the art are aware, there are other readily available means to attach the access panel 125 to the main housing 120 including a pressure fit along with a gasket; wherein the gasket being preferably comprised of a compressible elastomer such as rubber. Additionally, as those skilled in the art are aware, the access panel 125 is an optional feature of the present invention. One could design a respirator which does not include the access panel 125 without deviating from the teaching of the present invention; the access panel 125 makes it easy to replace the cartridge and filter but each may be installed into the filter housing without use of the access panel 125.

The main housing is preferably sized to be compact around a user's mouth and frontal portion of their face to allow for accommodation of additional pieces of PPE by the wearer. The main housing “cradles” the user's lower lip. The main housing also ergonomically contours to the user's face for better weight distribution.

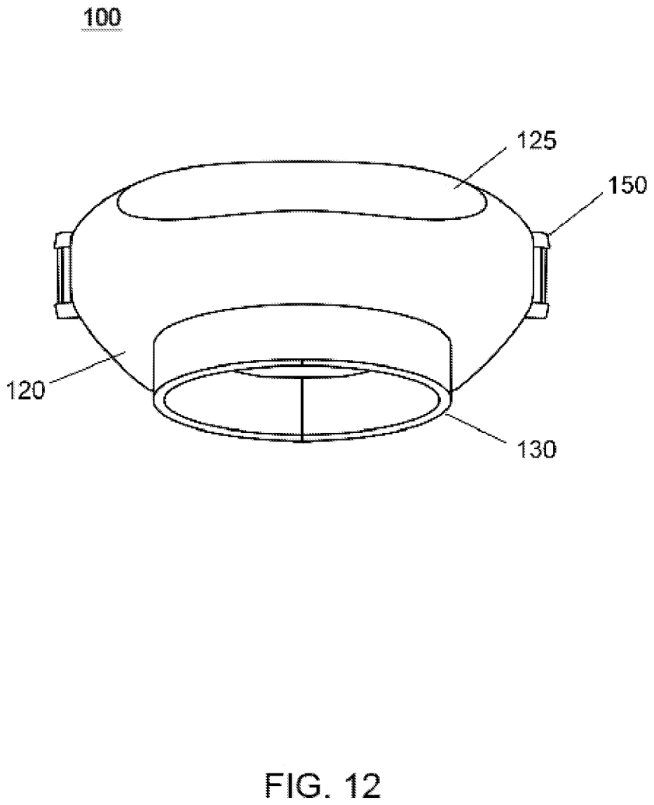

FIG. 12 depicts a frontal view of the B respirator 100 without the filter cartridge nor the dust cartridge installed.

The nose clamp is preferably made of a soft comfortable material such as silicone, silica gel, rubber, or the like. The nose clamp 110 may optionally include an additional elastic strap to minimize the possibility of misplacing the nose clamp 110 when the device is not in use. This additional elastic strap may be connected to the nose clamp 110 and the main housing 120 via readily available means such as elastic band or cordage This additional elastic strap also preferably has a buckle to allow for the user to change out nose pieces readily.

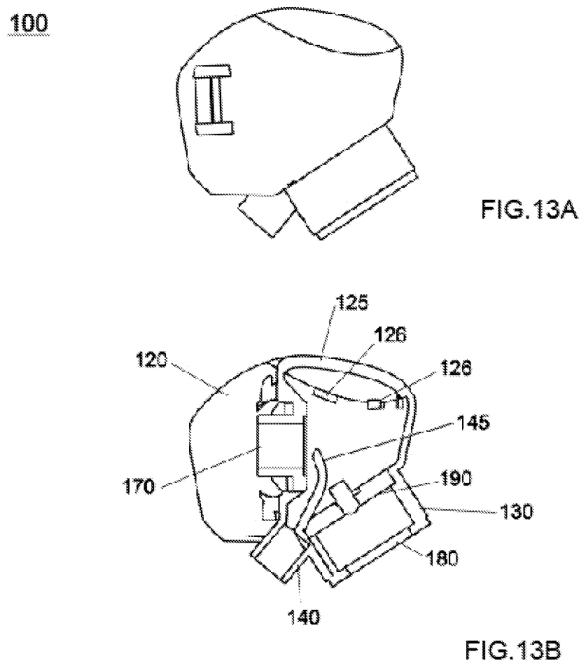

FIG. 13 depicts a cross sectional view of the exemplary respirator of the present invention. In FIG. 13, the mouthpiece 170, dust cartridge 180, fume filter 190, and access panel tabs 126 are visible. Additionally, there is a barrier 145 which prevents aerosolized droplets of saliva and other fluids such as mucus from impinging upon both the fume filter 190 and the interior of the main housing 110. Saliva and other fluids will feed by gravity into the saliva collector 140.

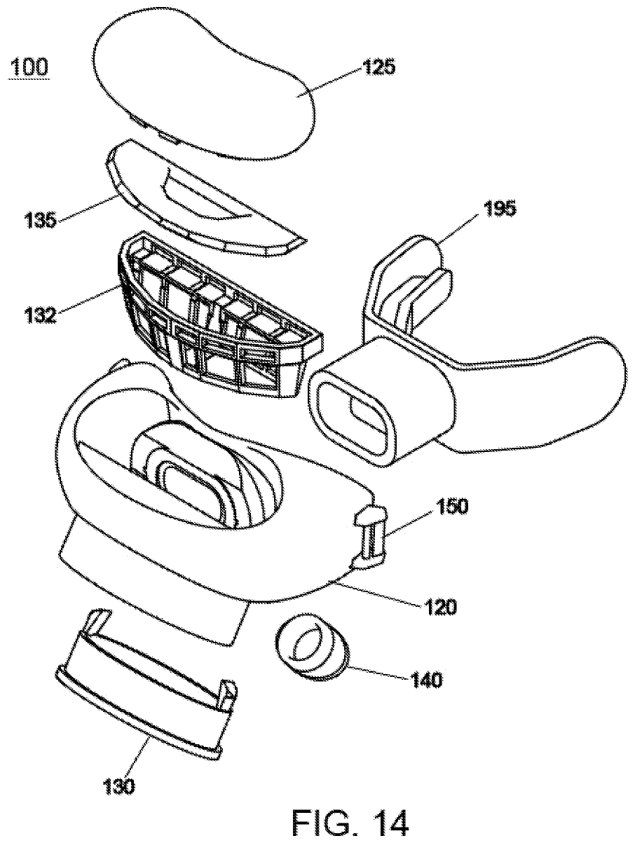

Referring to FIG. 14 and the preferred embodiment of the present invention depicted therein, an exploded view of the respirator of FIGS. 11-13 is depicted. In FIG. 14, the mouthpiece 195 of the present invention is shown. The mouthpiece 195 is replaceable as it could suffer wear or deformation with extended multiple uses. It is preferable to have the mouthpiece 195 fit into the housing via a pressure fit. In the preferred embodiment, the mouthpiece 195 is designed to have a slight outward taper which also helps to maintain a snug fit within the housing and prevents air from leaking through the mouthpiece into the housing. In a preferred embodiment of the present invention, the mouthpiece is comprised of a medical grade silicone, in another preferred embodiment the mouthpiece is comprised of Elvax 250 and Kraton, in another preferred embodiment the mouthpiece is comprised of a shrink fit polymer (similar to those high end mouth guards that are worn by athletes which may be warmed and then fit into the user's mouth to accommodate the user's bite pattern providing a very secure fit also known as a boil and bite mouthguard) to provide for an improved fit with the user's mouth and also to make it less fatiguing to wear than a respirator using a mouthpiece secured with a more traditional fitting polymer such as that used in the Dental Duty Mouthguard manufactured by World Wide Services LLC of Hamilton NJ 08619. As those skilled in the art are aware, the mouthpiece may also comprise EVA, rigid acrylic, polyethylene, polypropylene, and the like. It is also preferable to keep the opening of the mouthpiece a rectangular shape with tapered corners (similar to a 4:3 TV screen) as this will provide a better more comfortable fit than a mouthpiece of a circular or oval shape or a thinly opened rectangle with a large horizontal aspect ratio. As is readily visible in FIG. 14, the mouthpiece has a wide flair which may be contoured with a rounded shape or a series of bends to allow it to take on a “U” shaped curve to fit comfortably in a wearer's mouth. On the interior of this U shaped curve, there are a pair of bite wings located to allow the user to bite the mouthpiece and maintain its position in the user's mouth.

In the embodiment depicted in FIG. 14, a cage 132 to house the dust cartridge and fume filter is present and the cage 132 has a lid 135. It is preferable that the cage 132 and lid 135 are formed of a rigid or semirigid polymer such as elastic Resin, durable resin, Polypropylene, and the like which allows for the cage 132 to be rigid enough to house the fume filter and dust cartridge and to also allow it to be secured firmly within the main housing 120.

In the preferred embodiment, the housing 120 (shell) is preferably a 3 dimensionally printed plastic such as SLA (an acrylic based polymer). The housing 120 could also be made of other materials such as polycarbonate or polypropylene. It is preferable to keep the shell housing a rigid material to accommodate both weight distribution which provides for comfort when wearing the respirator and also allows for the filter cartridges to fit snuggly within the housing preventing ambient air to leak through the seal between the housing and cartridges.

The nose piece 110 and mouth piece 195 are each comprised preferably of a silicone based polymer to provide a consistent shape which is slightly deformable to fit the user's nose and mouth respectively.

The access panel 125 (which is an optional feature) is located on the top of the main body unit to allow access for changing out the fume filter and the dust cartridge. It also gives access for cleaning of the unit.

In another preferred embodiment of the present invention, the housing is comprised of a clear material such as acrylic, Plexiglas, or the like. In that preferred embodiment, the filters are comprised of a material that changes color over time or as it becomes saturated to allow the user to optimize the life of the filters and to replace them when they are “spent.”

In another preferred embodiment of the present invention, the unit housing and the cartridge housings, along with the mouthpiece, and the head strap may be colored to allow for personalization preferences of the wearer of the unit.

In the preferred embodiments where the nose piece is a separate piece not directly coupled to the main housing as depicted in FIGS. 11-14, there is an additional elastic strap to help prevent losing the nose piece. This elastic strap also preferably has a buckle to allow for the user to change out nose pieces readily.

In the embodiment depicted in FIGS. 11-14, there is a single opening in the B respirator which accommodates inhaling and exhaling. In another preferred embodiment, there is an additional “flapper” valve which allows the air exhaled from the user to leave through the separate exhaust port. This version helps prevent the filters from getting clogged by exhaled water vapor but also may allow for extremely small amounts of the ambient air and any contaminants in it to enter the respirator; so this version is preferably only used for non-life threatening environments such as keeping wood dust out of the user's respiratory system and would not be used for keeping out pathogens as an example.

The mouthpiece creates a seal with the user's lips. That is a key factor in how the respirator allows the user to have facial hair or other facial features which would render a standard half face respirator inoperable as it would be unable to create a seal with the user's face.

In the preferred embodiment, the head strap helps carry some of the weight of the respirator and allows the user to wear the B respirator without sustaining jaw fatigue. The B respirator has been designed to maintain weight around the mouthpiece rather than entirely above or below the mouthpiece which helps to allow the B respirator to seem lighter than it is to a user. It is preferable for the neck strap to be comprised of two ½″ elastic bands each terminating in ½ of a buckle such as a snap buckle to allow for ease in securing and then removing the buckle when the wearer places the B respirator into service and then removes it from service.

In the preferred embodiment where the nose piece is a separate piece not directly coupled to the main housing, there is an additional elastic strap to help prevent losing the nose piece. This elastic strap also preferably has a buckle to allow for the user to change out nose pieces readily.

In the preferred embodiment of the present invention the entire respirator, minus the replaceable cartridges may be cleaned via soap and water. The device may also be sterilized further via using UV-C radiation. The device could also be sterilized in a dishwasher, via boiling, or via an autoclave; though for most purposes simply cleaning it with hot soapy water will remove any contaminants or harmful microbes from the unit.

Referring to FIG. 14 and the preferred embodiment of the present invention depicted therein, an exploded view of the respirator of FIGS. 11-13 is depicted. In FIG. 14, the mouthpiece 195 of the present invention is shown. The mouthpiece 195 is replaceable as it could suffer wear or deformation with extended multiple uses. It is preferable to have the mouthpiece 195 fit into the housing via a pressure fit. In the preferred embodiment, the mouthpiece 195 is designed to have a slight outward taper which also helps to maintain a snug fit within the housing and prevents air from leaking through the mouthpiece into the housing. In a preferred embodiment of the present invention, the mouthpiece is comprised of a medical grade silicone, in another preferred embodiment the mouthpiece is comprised of Elvax 250 and Kraton, in another preferred embodiment the mouthpiece is comprised of a shrink fit polymer (similar to those high end mouth guards that are worn by athletes which may be warmed and then fit into the user's mouth to accommodate the user's bite pattern providing a very secure fit also known as a boil and bite mouthguard) to provide for an improved fit with the user's mouth and also to make it less fatiguing to wear than a respirator using a mouthpiece secured with a more traditional fitting polymer such as that used in the Dental Duty Mouthguard manufactured by World Wide Services LLC of Hamilton N.J. 08619. As those skilled in the art are aware, the mouthpiece may also comprise EVA, rigid acrylic, polyethylene, polypropylene, and the like. It is also preferable to keep the opening of the mouthpiece a rectangular shape with tapered corners (similar to a 4:3 TV screen) as this will provide a better more comfortable fit than a mouthpiece of a circular or oval shape or a thinly opened rectangle with a large horizontal aspect ratio. As is readily visible in FIG. 5, the mouthpiece has a wide flair which may be contoured with a rounded shape or a series of bends to allow it to take on a “U” shaped curve to fit comfortably in a wearer's mouth. On the interior of this U shaped curve, there are a pair of bite wings located to allow the user to bite the mouthpiece and maintain its position in the user's mouth.

In the embodiment depicted in FIG. 14, a cage 132 to house the dust cartridge and fume filter is present and the cage 132 has a lid 135. It is preferable that the cage 132 and lid 135 are formed of a rigid or semirigid polymer such as elastic Resin, durable resin, Polypropylene, and the like which allows for the cage 132 to be rigid enough to house the fume filter and dust cartridge and to also allow it to be secured firmly within the main housing 120.

In the preferred embodiment, the housing 120 (shell) is preferably a 3 dimensionally printed plastic such as SLA (an acrylic based polymer). The housing 120 could also be made of other materials such as polycarbonate or polypropylene. It is preferable to keep the shell housing a rigid material to accommodate both weight distribution which provides for comfort when wearing the respirator and also allows for the filter cartridges to fit snuggly within the housing preventing ambient air to leak through the seal between the housing and cartridges.

The nose piece 110 and mouth piece 195 are each comprised preferably of a silicone based polymer to provide a consistent shape which is slightly deformable to fit the user's nose and mouth respectively.

The access panel 125 (which is an optional feature) is located on the top of the main body unit to allow access for changing out the fume filter and the dust cartridge. It also gives access for cleaning of the unit.

In another preferred embodiment of the present invention, the housing is comprised of a clear material such as acrylic, Plexiglas, or the like. In that preferred embodiment, the filters are comprised of a material that changes color over time or as it becomes saturated to allow the user to optimize the life of the filters and to replace them when they are “spent.”

In another preferred embodiment of the present invention, the unit housing and the cartridge housings, along with the mouthpiece, and the neck strap may be colored to allow for personalization preferences of the wearer of the unit.

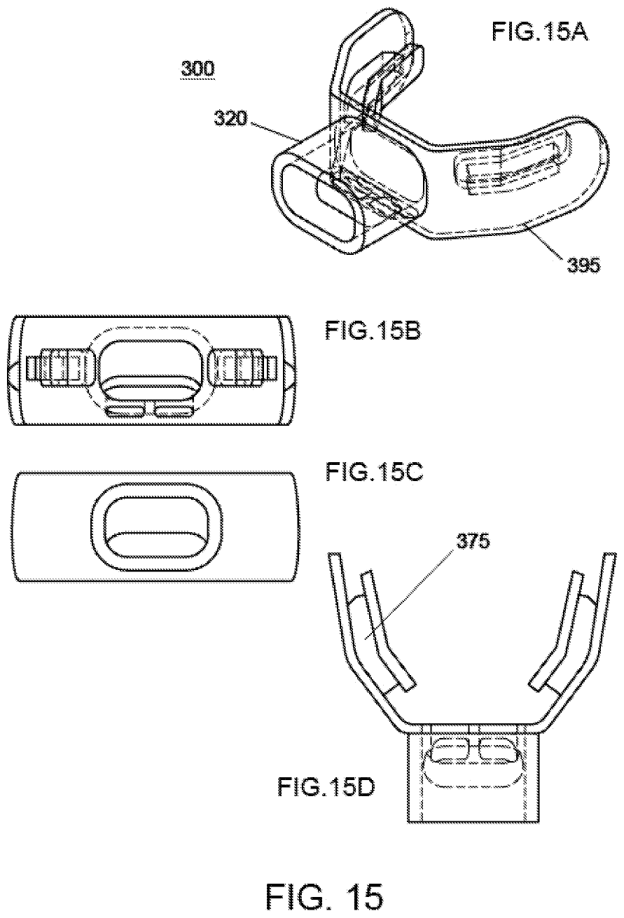

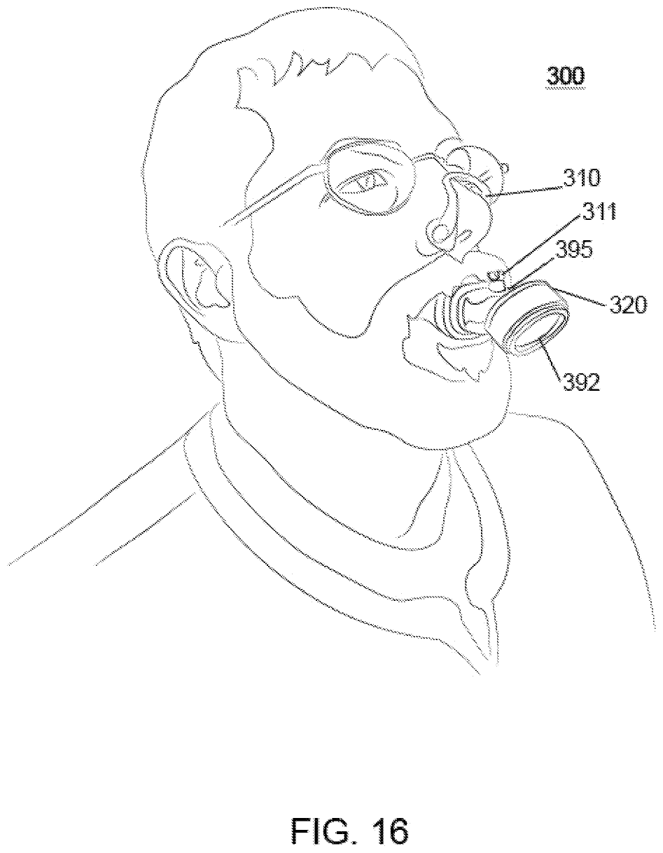

In another preferred embodiment of the present invention 300, depicted via multiple views in FIGS. 15A-D and FIG. 16, the housing 320 is miniaturized to allow for the unit to be an escape respirator. Unit becomes pocket sized and light weight. The entirety of the main housing 320 becomes a cartridge housing and the cartridge housing is attached directly to a mouth piece 395. FIGS. 15A-15D present multiple views of the mouthpiece 395 of the escape respirator 300. The mouth piece 395 is designed with a pair of wings which fit into a user's mouth. On the inner surface of each wing a bite wing 375 is provided for the user to bite onto the respirator mouth piece, thus securing it to the user's mouth. The seal for the escape respirator is provide by the user's lips encompassing the mouth piece of the escape respirator as depicted in FIG. 16.

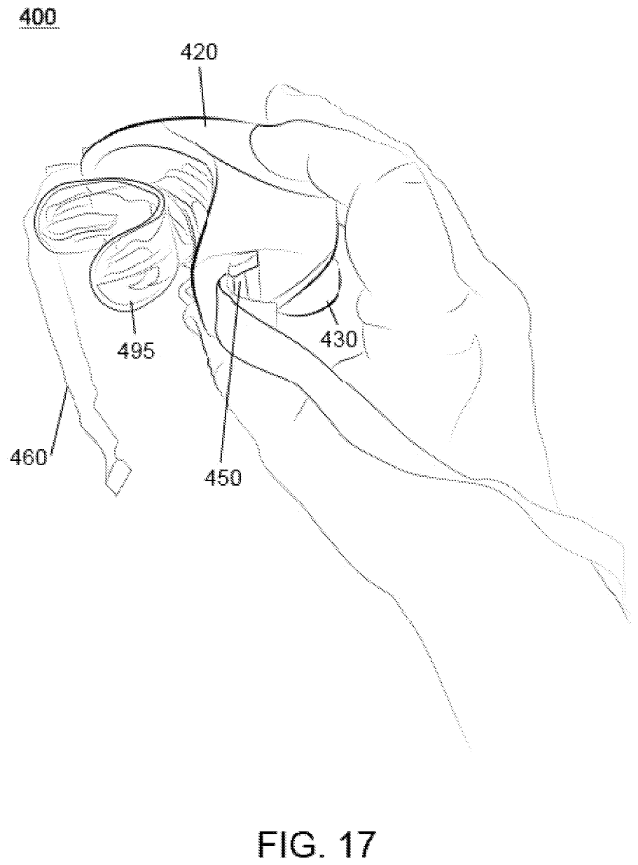

The entire escape respirator unit would be disposed of after one use. This unit is operable for a short duration of time to allow the wearer to escape a toxic environment. This unit would also preferably be individually wrapped in a sterile plastic bag and opened only when life threatening situation should warrant its use. The escape respirator is preferably made from a polymer such as nylon. As those skilled in the art are aware, the respirator may also be comprised of a polymer such as HDPE, ABS, or the like. The surface of the bite wing may be coated with a medical grade soft touch polypropylene to increase user comfort. A back side view of another embodiment 400 of the escape respirator is depicted in FIG. 17. Escape respirator 400 is compact similarly to the escape respirator 300 previously depicted. Escape respirator 400 has a separate main housing and cartridge housing which allows for the fume filter and dust cartridges to be removed and the respirator may be used multiple times.

FIG. 17 provides a view of the respirator in a user's hand in preparation of being put into use. The nose plug 310, main housing 320, and the fume filter 395 and dust cartridge 392 are depicted. Additionally, a slip holder 311 to store the nose plug prior to the unit being placed in service is depicted. This slip holder allows for the user to not lose or misplace the nose plug 310 during what could very likely be a stressful situation that the user has encountered when needing to use the respirator 300.

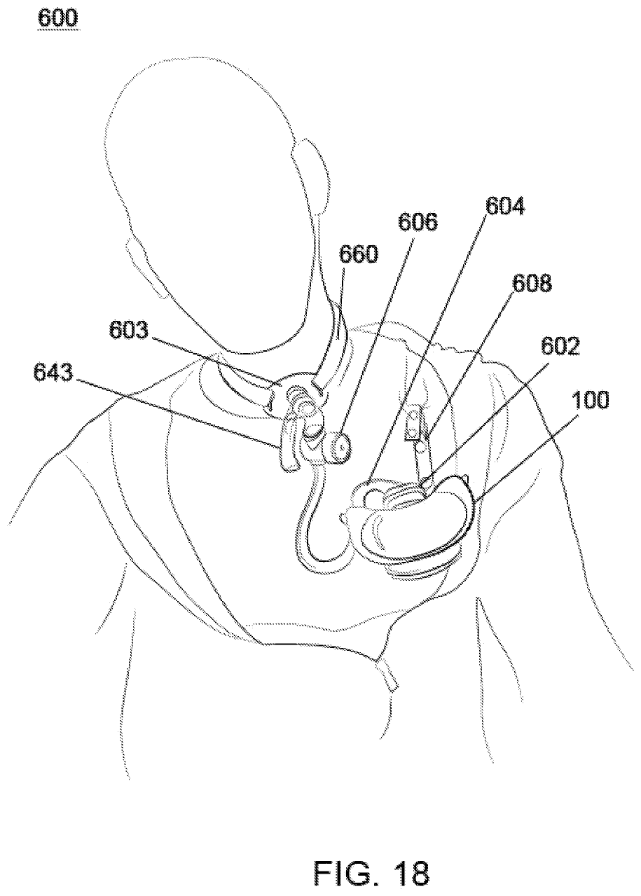

Referring to FIG. 18 and the preferred embodiment of the present invention in use depicted therein, a B respirator 600 for use by individuals that breathe through a tracheotomy is depicted. The B respirator 600 comprises a standard B respirator 100 which is equipped with a hose to mouth piece adaptor, a first hose 604, an exhale valve 606, a second hose 607, and a tracheotomy plate 603. Said exhale valve 606 is connected to said first hose 604 on one end and is connected to said second hose 607 on the other end. The second hose is connected to a tracheotomy plate 603 which allows for the B respirator to make an air tight seal with the individual's tracheotomy stomata. There is additionally a saliva collection bag 643 attached to the second hose which minimizes the collection of saliva from the user. The tracheotomy plate 603 is preferably held in place via a neck strap which is attached directly to the tracheotomy plate 603.

The standard B respirator 100 is preferably attached to the user's clothing via any readily available clip that has been attached to a neck strap 160 of the standard B respirator.

A nose clamp such as nose clamp 110 may optionally be used as well for users that still may breathe partially through their nose.

The nose clamp may also optionally be replaced by a nose plug such as nose plug 210. The nose clamp or nose plug may optionally include an additional elastic strap to minimize the possibility of misplacing the nose clamp when the device is not in use. This additional elastic strap may be connected to the nose clamp and the main housing 520 via readily available means such as . . . This additional elastic strap also preferably has a buckle to allow for the user to change out nose pieces readily.

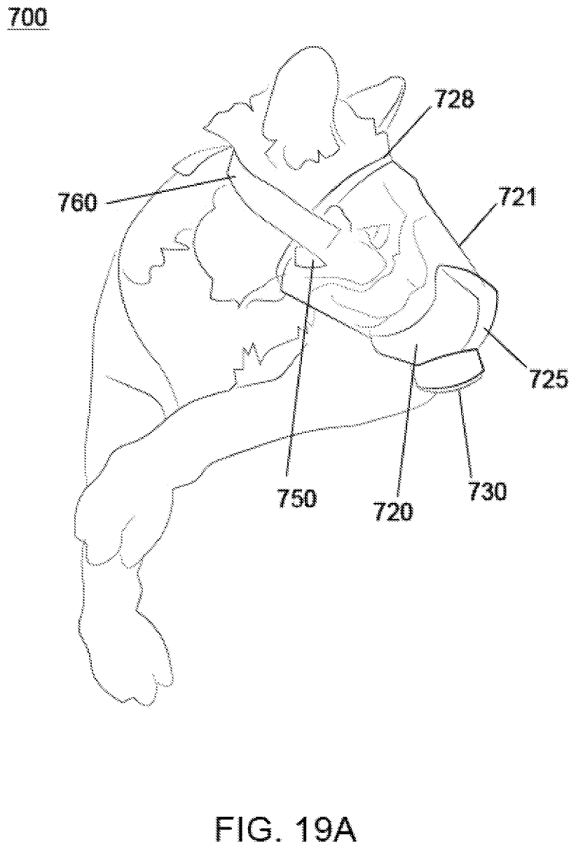

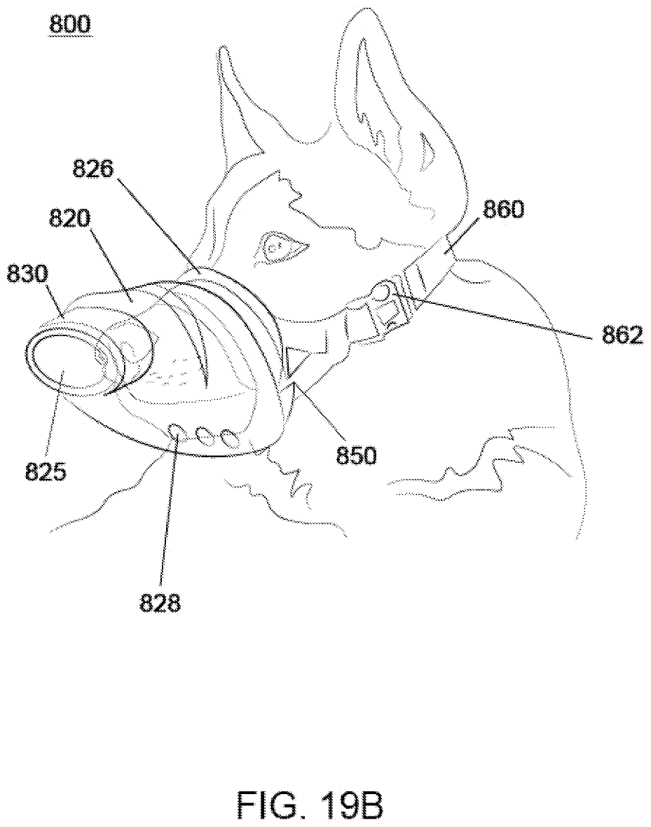

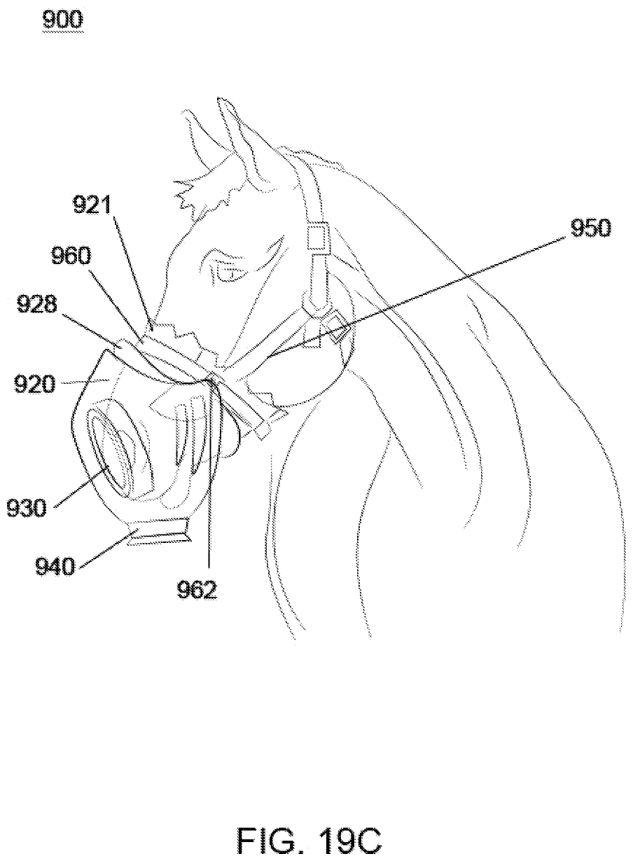

Referring to FIG. 19A and the preferred embodiments of the present invention in use depicted therein, a B respirator 700 for use by animals are depicted. The B respirator 700 is designed for use by small animals or animals without a pronounced protruding snout. The respirator is designed to have a clear face container 721 which covers the animal's entire face and is made of a clear material so the animal may see through the device. This clear face container 721 is sealed to the animal's face via a flexible rubber seal 728 combined with use of an adjustable head strap 760 which allows the animal's trainer to tighten the B respirator onto the animal's head and maintain a nearly air tight seal between the clear face container 721 and the fur of the animal's face. The clear face container may be comprised of a clear plastic such as acrylic, clear polyvinyl chloride (PVC), and the like. The head strap 760 is connected to the clear face container 721 via a means for attaching the strap 750 to the main housing 720. At the front (away from the animal) of the clear face container 721 is a main housing 720 equipped with an access panel to insert a fume filter and a dust cartridge into a cartridge housing 730.

Additionally, as those skilled in the art are aware, the access panel 725 is an optional feature of the present invention. One could design a respirator which does not include the access panel 725 without deviating from the teaching of the present invention; the access panel 725 makes it easy to replace the cartridge and filter but each may be installed into the filter housing without use of the access panel 725.

The main housing 720 is preferably sized to be compact in front of the clear plastic 721 to minimize the vision blockage that it would create. In a preferred embodiment, the main housing, access panel, and cartridge housing are comprised of clear polymers.

In another preferred embodiment of the small animal respirator (not depicted) the head straps are designed with buckles in behind the animal's head to initially fit loosely over the animal's head when the respirator is first put on the animal and then the strap may be pulled tighter through the a buckle. This will make it easier to fit the respirator onto the head of the animal if the animal struggles initially when the respirator is placed on the animal's head.

Referring to FIG. 19B and the preferred embodiments of the present invention in use depicted therein, another embodiment of a B respirator 800 designed for use by animals is depicted. The B respirator 800 is designed for use by midsized animals that have a pronounced protruding snout to which the B respirator 800 can be securely attached. The B respirator is designed to have a main housing 820 which covers the animal's entire snout and is preferably comprised of a rigid or semirigid polymer. This main housing is sealed to the animal's snout via a flexible rubber seal 828 combined with use of an adjustable head strap 860 which allows the animal's trainer to tighten the B respirator onto the animal's head and maintain a nearly air tight seal between the main housing 820 and the fur of the animal's face. The head strap 860 is connected to the main housing 820 via a means for attaching the strap 850 to the main housing 820. The head strap 860 also is preferably equipped with a means for easily snapping the respirator into place and removing the respirator. Such means 862 may include a snap clasp; Velcro; a button, and the like. Towards the front (away from the animal) of the main housing 820 is preferably equipped with an access panel 825 to insert a fume filter and a dust cartridge into a cartridge housing 830.

Additionally, as those skilled in the art are aware, the access panel 825 is an optional feature of the present invention. One could design a respirator which does not include the access panel 825 without deviating from the teaching of the present invention; the access panel 825 makes it easy to replace the cartridge and filter but each may be installed into the filter housing without use of the access panel 825.

The main housing 820 is preferably sized to be compact to minimize discomfort and distress experienced by the animal. Additionally, to make it easier for the animal to breathe, the main housing depicted in FIG. 10B is constructed with a series of exhale vents 828 designed with flapper valves to allow the animal to exhale through the vents 828 but not inhale through the vents 828. The vents 828 are an optional feature of the B respirator 800 and the teaching is not avoided by removing them. In another preferred embodiment, the main housing, access panel, and cartridge housing are comprised of clear polymers.

In another preferred embodiment of the midsized animal respirator (not depicted) the head straps are designed with buckles in behind the animal's head to initially fit loosely over the animal's head when the respirator is first put on the animal and then the strap may be pulled tighter through the a buckle. This will make it easier to fit the respirator onto the head of the animal if the animal struggles initially when the respirator is placed on the animal's head.

Referring to FIG. 19C and the preferred embodiments of the present invention in use depicted therein, another embodiment of a B respirator 900 designed for use by animals is depicted. The B respirator 900 is designed for use by large animals that have a pronounced protruding snout to which the B respirator 900 can be securely attached. The B respirator is designed to have a main housing 920 which covers the animal's entire snout and is preferably comprised of a rgid or semirigid polymer. This main housing is sealed to the animal's snout via a flexible rubber seal 928 combined with use of an adjustable strap 960 which allows the animal's trainer to tighten the B respirator onto the animal's head and maintain a nearly air tight seal between the main housing 920 and the fur of the animal's face. The strap 960 is connected to the main housing 920 via a means for attaching the strap 950 to the main housing 920. For animals that wear a halter such as a horse, pony, or goat, the strap 960 can connect to the animal's existing halter. If the animal does not wear a halter, then the strap 960 can wrap around behind the animal's head as is the case with the strap 860 for the midsized animal. Towards the front (away from the animal) of the main housing 920 is preferably equipped with an access panel 925 to insert a fume filter and a dust cartridge into a cartridge housing 930.

Additionally, as those skilled in the art are aware, the access panel 925 is an optional feature of the present invention. One could design a respirator which does not include the access panel 925 without deviating from the teaching of the present invention; the access panel 925 makes it easy to replace the cartridge and filter but each may be installed into the filter housing without use of the access panel 925.

The main housing 920 is preferably sized to be compact to minimize discomfort and distress experienced by the animal. Additionally, to make it more comfortable for the animal to wear, the main housing depicted in FIG. 10C is constructed with a saliva catcher 940. The saliva catcher 940 is an optional feature of the B respirator 900 and the teaching is not avoided by removing it. In another preferred embodiment, the main housing, access panel, and cartridge housing are comprised of clear polymers.

In another preferred embodiment of the large animal respirator (not depicted) the head straps are designed with buckles in behind the animal's head to initially fit loosely over the animal's head when the respirator is first put on the animal and then the strap may be pulled tighter through the a buckle. This will make it easier to fit the respirator onto the head of the animal if the animal struggles initially when the respirator is placed on the animal's head.

In the preferred embodiments of the present invention depicted throughout this specification the entire respirator, minus the replaceable cartridges may be cleaned via soap and water. The device may also be sterilized further via using UV-C radiation. The device could also be sterilized in a dishwasher, via boiling, or via an autoclave; though for most purposes simply cleaning it with hot soapy water will remove any contaminants or harmful microbes from the unit.

Although several embodiments of the present invention, methods to use said, and its advantages have been described in detail, it should be understood that various changes, substitutions, and alterations can be made herein without departing from the spirit and scope of the invention as defined by the appended claims. The various embodiments used to describe the principles of the present invention are by way of illustration only and should not be construed in any way to limit the scope of the invention. Those skilled in the art will understand that the principles of the present invention may be implemented in any suitably arranged device.

I claim:

1. A respirator for individuals with facial hair or other non-standard physical features which allows the respirator to create an air tight seal between the respirator and the user comprising a main housing, said main housing featuring an upper and lower outer surface and a front and back side; a mouthpiece; a cartridge housing; a dust cartridge; a nose piece; and a means for securing said respirator to the user; wherein said cartridge housing is formed along the lower front outer surface of the main housing; said dust cartridge is placed inside the cartridge housing; said mouthpiece is secured to the back of the main housing via a compression fit;
said means for securing said respirator to the user comprises at least one flexible strap; said at least one flexible strap is attached to said main housing via a means for securely attaching said at least one elastic band to said main housing.

2. The respirator of claim 1 wherein the main housing is compact.

3. The respirator of claim 2 wherein further comprising a fume filter wherein said fume filter is placed inside the cartridge housing and is located inside said dust cartridge.

4. The respirator of claim 3 wherein said main housing is comprised of a semi rigid plastic material.

5. The respirator of claim 3 wherein said at least one flexible strap comprises at least one elastic band.

6. The respirator of claim 4 wherein said nose piece comprises a nose clamp.

7. The respirator of claim 4 wherein said nose piece comprises an access panel, two small tubes, and a housing wherein the two small tubes each fit into said housing, and wherein the two small tubes further fit into the access panel, wherein said access panel further is fitted into the housing.

8. The respirator of claim 7 further comprising at least one additional flexible strap wherein said means for securing said respirator to the user comprises a series of flexible straps; said flexible straps are attached to said main housing via a means for securely attaching said flexible straps to said main housing said nose piece comprises a main body with a lower side and two tubes, said tubes protruding via a first end from the lower side of the main body and attached to the main housing via a second end.

9. The respirator of claim 3 further comprising lighting.

10. The respirator of claim 9 wherein the lighting comprises multiple lights for communication purposes and an additional light, said additional light providing illumination for the user to see in poorly lit areas.

11. The respirator of claim 9 wherein the lighting is touch activated.

12. The respirator of claim 1 further comprising a sealing plate to seal a tracheostomy stomata of a user and a hose wherein said hose connects the sealing plate to the respirator; further comprising a means to attach the respirator onto the clothing of the user.

13. An escape respirator for individuals with facial hair or other non-standard physical features which allows the respirator to create an air tight seal between the respirator and the user comprising a main housing, said main housing featuring an upper and lower outer surface and a front and back side; a mouthpiece; a cartridge housing; a dust cartridge; a nose piece; wherein said dust cartridge is placed inside said cartridge housing wherein said cartridge housing is formed along the lower front outer surface of the main housing; said dust cartridge is placed inside the cartridge housing; said mouthpiece is secured to the back of the main housing via a compression fit; wherein said respirator is secured to the user by the user biting on the mouthpiece.

14. The escape respirator of claim 13 further comprising a fume filter wherein said fume filter is placed inside the cartridge housing and is located inside said dust cartridge wherein said cartridge housing is formed along the lower front outer surface of the main housing

15. A respirator wherein the user of the respirator is an animal and the respirator further comprises a main housing, said main housing featuring an upper and lower outer surface and a front and back side; a flexible rubber seal; said flexible seal attached to the outer surface of the backside of the main housing; a cartridge housing; a dust cartridge; a fume cartridge; exhaust ports; wherein said exhaust ports are located in the front of the main housing and allow the animal's exhaled breath to evacuate the respirator; and a means for securing said respirator to the user; wherein said cartridge housing is formed along the lower front outer surface of the main housing; said dust cartridge is placed inside the cartridge housing; said fume filter is placed inside the cartridge housing after said dust cartridge is placed inside the cartridge housing; said flexible seal is in contact with the animal's face; said means for securing said respirator to the user comprises a series of at least one flexible strap; said series of at least one flexible strap is attached to said main housing via a means for securely attaching said at least one flexible strap to said main housing.

16. The respirator of claim 15 further comprising at least one additional flexible strap and at least two buckles wherein the at least one flexible strap is comprised of a wide elastic band and is connected to a buckle; wherein the additional flexible strap connects two buckles; and the at least one flexible strap can be further tightened on a buckle by pulling the free end of the strap through the buckle.

17. The respirator of claim 15 further comprising a clear face shield; said face shield is attached to the back side of the main housing and the flexible seal is attached to the back side of the clear face shield.

18. The respirator of claim 15 further comprising an access panel attached to said main panel.

19. The respirator of claim 15 further comprising a saliva catcher.
